(19) United States
(12) Patent Application Publication
(10) Pub. No.: US 2002/0061957 A1
(43) Pub. Date: May 23, 2002

(54) Coating composition for undercoat and coating method for repair employing the same

(76) Inventors: Shinji Tomita, Hyogo (JP); Takeo Yanagiguchi, Hyogo (JP); Nobuhito Akane, Kanagawa (JP); Sadamu Hara, Hyogo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/963,526

(22) Filed: Sep. 27, 2001

(30) Foreign Application Priority Data
Sep. 28, 2000 (JP) 2000-296618

(51) Int. Cl. C08K 3/00

(52) U.S. Cl. 524/507

(57) ABSTRACT

A coating composition for undercoat of the present invention comprises (A) an acrylic resin having a hydroxyl value of 30 to 85 and a weight average molecular weight of 1000 to 30000, (B) a pigment, (C) resin fine particles, (D) a polyisocyanate compound, and (E) a curing catalyst. The employment of an isocyanate-rich two-pack type coating effects a high content of solid matter at spray coating which allows the formation of a thick film, and enables the formation of a coated film curable within a short period of time after coating and excellent in substrate-shielding ability and solvent resistance.

### TECHNICAL FIELD OF THE INVENTION

The present invention relates to a coating composition for undercoat effecting a high content of solid matter at coating and capable of forming a coated film excellent in drying ability and substrate-shielding ability, particularly useful in the automobile-repairing field, and a coating method for repair employing the same.

### BACKGROUND OF THE INVENTION

Hitherto, the coating for repairing outer panels of automobiles and the like usually comprises a number of steps, for example, steps of removing old coated film at a damaged part and sanding, applying thickly a putty for plate working onto the part with a putty knife or the like, sanding the puttied surface after drying, applying synthetic plaster thereon with a knife so that the neighboring old coated film is also puttied, sanding the puttied surface after drying, and giving successive primer surfacer or filler coat and topcoat thereon. Particularly, the steps from puttying to primer surfacer or filler coat are steps for reducing strains at the damaged part and adjusting the body to the original shape, so-called body shape remedy coating process, so that a lot of efforts and time are consumed because some kinds of putties are applied in several steps and the coated surface is sanded after each coating for attaining good finish. Also, even at the repair of striated or spotted petty scratch, sanding is carried out over a wide range part centering the scratch and including the periphery and then the sanded part is puttied.

### SUMMARY OF THE INVENTION

In order to make the best use of the characteristics of both of the putty for plate working and the synthetic plaster described above, it is usually necessary to employ both putties in combination. Furthermore, since the applied surface is rough, the surface is sanded with a coarse water-proof abrasive paper in the case of the putty for plate working, so that marks from which pigment and the like are pared off and paper trails remain on the putty-applied surface. Therefore, the surfaces where the synthetic plaster and primer surfacer or filler are applied thereon should be sanded with more fine water-proof abrasive paper.

As described above, in order to shorten the repairing coating time, it is required that the steps from the puttying to the primer surfacer or filler coating should be simplified and the sanding time and the time until giving topcoat should be shortened.

For the purpose, it is considered to simplify the puttying step and sanding process by imparting a function capable of forming a thick film to the primer surfacer or filler so as to shield sufficiently the inconvenient parts on the puttied surface such as the paper trails owing to insufficient sanding, but it is difficult to balance the function with performance of coated films such as drying ability and solvent resistance.

As a result of extensive studies for solving the above problems, the present inventors have found that the employment of an isocyanate-rich two-pack type coating wherein a specific acrylic polyol, pigment and resin fine particles are used effects a high content of solid matter at spray coating which allows the formation of a thick film, and enables the formation of a coated film curable within a short period of time after coating and excellent in substrate-shielding ability and solvent resistance, whereby the sanding time and the time until giving topcoat can be shortened and a puttying step can be simplified in the case of a petty scratch. Based on the findings, they have accomplished the present invention.

That is, the present invention relates to a coating composition for undercoat that comprises (A) an acrylic resin having a hydroxyl value of 30 to 85 and a weight average molecular weight of 1000 to 30000, (B) a pigment, (C) resin fine particles, (D) a polyisocyanate compound, and (E) a curing catalyst. The ratio of the isocyanate group in the (D) component to 1 equivalent of the hydroxyl group in the (A) component is 2.0 to 4.0 equivalents. The content of the (B) component is from 100 to 500 parts by weight relative to 100 parts by weight of the resin solid matter. The (C) component is mixed so as to be from 0.1 to 5% by weight as a solid matter relative to the weight of the (B) component.

The acrylic resin (A) may be a resin obtainable by polymerizing an acrylic monomer having hydroxyl group as an essential monomer and other acrylic monomer and/or a vinyl monomer.

This invention is also related to a coating method for repair a coating that includes steps of conducting surface treatment at a part to be repaired, giving undercoat, and giving topcoat. At the undercoating step, the coating composition above is used.

### PREFERRED EMBODIMENTS OF THE INVENTION

In the present invention, the acrylic resin (A) may be an acrylic resin having a hydroxyl value of 30 to 85, preferably 40 to 70, and a weight average molecular weight of 1000 to 30000, preferably 3000 to 20000. When the hydroxyl value is less than 30, the performance of the coated film is deteriorated, and when it exceeds 85, the content of the solid matter at coating decreases. Also, when the weight average molecular weight is less than 1000, the performance of the coated film formed remarkably is deteriorated, and when it exceeds 30000, the viscosity of the coating composition becomes high and the content of the solid matter at coating decreases. Thus, these cases are not preferred. Moreover, the acrylic resin (A) has preferably a glass transition temperature (Tg) within the range of 40 to 90° C. in view of the enhancement of drying ability.

As the monomers constituting the acrylic resin (A), an acrylic monomer having hydroxyl group is an essential monomer and other acrylic monomer and/or a vinyl monomer is used, and the resin is obtainable by subjecting these monomers to usual radical polymerization. Examples of the monomer having hydroxyl group include hydroxyalkyl (metha)acrylates such as 2-hydroxyethyl methacrylate, 2-hydroxyethyl acrylate, hydroxypropyl methacrylate, hydroxypropyl acrylate, and 4-hydroxybutyl acrylate; lactone-modified α,β-ethylenic unsaturated monomers wherein 1 to 10 mol of a lactone such as ε-caprolactone or γ-butyrolactone is added to hydroxyalkyl (meth)acrylates; and the like. Moreover, examples of other acrylic monomer and/or vinyl monomer includes methyl (meth)acrylate, n-butyl (meth)acrylate, iso-butyl (meth)acrylate, tert-butyl (meth)acrylate, 2-ethylhexyl (meth)acrylate, cyclohexyl (meth)acrylate, lauryl (meth)acrylate, styrene, α-methylstyrene, (meth)acrylic acid, and the like. As the usual radical polymerization, a solution polymerization may be mentioned, for example.

In the present invention, as the pigment (B), a body pigment such as talc, mica, barium sulfate, kaolin, calcium carbonate, clay, silica, quartz, glass, or the like can be used and further, a color pigment such as titanium white, red iron oxide, carbon black, iron black, or the like may be contained. The content of the pigment (B) is from 100 to 500 parts by weight, preferably 150 to 350 parts by weight relative to 100 parts by weight of the resin solid matter. When the content is less than 100 parts by weight, the workability at sanding is inferior, and when it exceeds 500 parts by weight, finishing property after topcoat is deteriorated. Thus, both cases are not preferred. For dispersing the pigment (B), it is desirable to employ a pigment dispersant, and particularly, a dispersant containing a tertiary amino group is suitably employed in view of a lowered viscosity of the dispersed paste.

In the present invention, the resin fine particles (C) include resin particles such as hitherto known polymer beads, finely pulverized polymers of the above monomers, gelatinized polymer fine particles (for example, cf. Japanese Patent Application Laid-Open Nos. 126287/1976, 133233/1978, 133236/1978, 76447/1981, and 129065/1983 (U.S. Pat. No. 4,468,493)), and the like. In particular, gelatinized polymer fine particles obtainable by the emulsion polymerization of a monomer mixture containing a divinyl monomer in the presence of a reactive emulsifier containing allyl group (for example, cf. Japanese Patent Application Laid-Open No. 66770/1991 (U.S. Pat. No. 5,348,998)) may be suitably employed owing to an excellent dispensability toward the (A) and (B) components.

Examples of the divinyl monomer for use in the production of the gelatinized polymer particles include ethylene glycol di(meth)acrylate, 1,6-hexanediol diacrylate, and the like. And, examples of the other monomer include hitherto known polymerizable unsaturated monomers such as alkyl (meth)acrylates, monomers containing hydroxyl group, and styrene. These monomers are optionally selected. Moreover, a water-soluble azo-amide compound or the like may be employed as a polymerization initiator at the emulsion polymerization.

The size of the above resin fine particles (C) may be optionally selected without particular limitation, but is suitably in the range of usually 30 μm or less, preferably 0.05 to 10 μm. The adjustment of the particle size can be effected by a conventionally known method, and for example, it is achieved by controlling the kind and amount of the reactive emulsifier in the case of the above gelatinized polymer fine particles.

The resin fine particles (C) is mixed so as to be from 0.1 to 5% by weight, preferably 0.5 to 2% by weight as a solid matter relative to the weight of the above (B) component. When the mixing ratio of the resin fine particles (C) exceeds 5% by weight, the viscosity of the composition becomes high and workability is deteriorated. On the other hand, the precipitation-preventing effect toward the (B) component is not attained at the storage of the coating composition particularly under a high temperature environment when it is less than 0.1% by weight. Thus, both cases are not preferred.

In the present invention, the polyisocyanate compound (D) is a polyisocyanate compound having two or more, preferably three isocyanate groups in one molecule. Concrete examples thereof include polyisocyanate compounds such as hexamethylene diisocyanate, trimethylhexamethylene diisocyanate, isophorone diisocyanate, hydrogenated xylylene diisocyanate, xylylene diisocyanate, m-tetramethylxylylene diisocyanate, tolylene diisocyanate, 4,4′-diphenylmethane diisocyanate, and lysine diisocyanate; adducts of these polyisocyanate compounds with a polyhydric alcohol, a low-molecular-weight polyester resin, or water; cyclized polymers of the polyisocyanate compounds described above; isocyanate.biuret compounds; and the like. These may be used singly or as a mixture of two or more.

In the present invention, the above (A) component and the above (D) component are mixed so that the ratio of the isocyanate group in the (D) component to 1 equivalent of the hydroxyl group in the (A) component becomes 2.0 to 4.0 equivalents, preferably 2.2 to 3.5 equivalents. When the ratio of the (D) is less than 2.0 equivalents, the curing of the coated film is insufficient and is apt to dissolve in the solvent contained in a coating composition for topcoat. When the ratio exceeds 4.0 equivalents, the drying ability of the coated film is remarkably deteriorated. Thus, both cases are not preferred.

In the present invention, as the curing catalyst (E), hitherto known urethanization catalysts can be employed without particular limitation, and examples thereof include metal compounds such as bismuth nitrate, lead oleate, tin octylate, dibutyltin dilaurate, dibutyltin bis(acetylacetonate), titanium tetrachloride, dibutyltitanium dichloride, tetrabutyl titanate, iron trichloride, and zinc octylate; tertiary amines; and the like. The content of the curing catalyst (E) is suitably from 0.1 to 10% by weight, preferably 0.2 to 5% by weight relative to the resin solid matter. When the content is less than 0.1% by weight, the curing of the coated film is insufficient and is apt to dissolve in the solvent contained in a coating composition for topcoat. On the other hand, when it exceeds 10% by weight, the viscosity after mixing a main agent with a curing agent increases rapidly. Thus, both cases are not preferred.

The composition of the present invention may be optionally mixed with additives for coating compositions such as an organic solvent, a cellulose derivative, a non-aqueous dispersing resin, and a leveling agent including a dimethylsiloxane copolymer, or the like.

The composition of the present invention thus obtained is a two-pack type composition, and at the use, a main agent containing the (A), (B), (C), and (E) components is mixed with a curing agent containing the (D) component immediately before the coating. Moreover, in the composition of the present invention, it is possible to increase the solid matter at coating to 55 to 70% by the above compositional ratio.

The present invention further provides a coating method for repair wherein the above composition is employed for undercoat.

The coated films for repair to which the method of the present invention can be applied may be coated films coated on outer panels of automobiles and household electrical goods, for example. These are mostly multilayer coated film comprising undercoat film, intermediate coat film (may be sometimes omitted), and topcoat film. Moreover, the coated film may be either solid type or metallic type. The total film thickness of these multilayer coated films is usually in the range of 50 to 300μ as a cured coated film. These coated film may be either three-dimensionally crosslinked and cured or not crosslinked.

In the method of the present invention, the damaged part of the coated film is first pared off, and the part centering the damaged part and including the periphery when required is sanded and then degreased if necessary. When the damage is a line scratch, a spot scratch, or the like, the composition of the present invention can be directly applied to the degreased part. Depending on the damage, the pared part is charged with various putties and then the composition of the present invention can be applied thereto. The putty can be charged according to the method known per se, for example, with knife application. The putties may be a hitherto known putty for plate working, synthetic plaster, and the like. For example, there may be mentioned nitrocottons, acrylic resins, epoxyacrylate resins, unsaturated polyester resins, urethane resins, and the like. In the case that the putty is applied, it is preferred to sand the puttied surface after drying, but there arises no trouble even when the sanded surface is rough since the composition of the present invention has a good substrate-shielding ability.

The composition of the present invention can be applied according to hitherto known coating method, and particularly suitable is a spray coating. The thickness of coated film is within the range of 50 to 500 μm as a dry film thickness, and a thick coating is possible.

After the drying of the coated film derived from the composition of the present invention, the film is sanded when required, and then topcoat is given. For the topcoat, hitherto known coating methods can be applied, including one coat finish wherein a base coating composition comprising a metallic pigment and/or color pigment is mixed or two-coat finish wherein a base coating composition and a clear coating composition are used. For the coating, an organic solvent-type or aqueous coating composition for topcoat usually used for repair such as an acrylic lacquer, a urethane-curable coating, or a fluorine resin coating can be employed without particular limitation, and a urethane-curable coating is particularly preferred.

### EXAMPLES

The following will explain the present invention in detail with reference to examples. By the way, “part(s)” and “%” mean “part(s) by weight” and “% by weight”, respectively.

### Production of Acrylic Resin

A reactor was fitted with a thermometer, a thermostat, a stirrer, a reflux cooler, and a dropping pump, and was charged with xylene (42 parts) and butyl acetate (10 parts), and then the whole was warmed to 110° C. under stirring. A mixture of monomers and a polymerization initiator comprising styrene (10 parts), methyl methacrylate (10 parts), n-butyl methacrylate (5 parts), i-butyl methacrylate (60 parts), methacrylic acid (1 part), 2-hydroxyethyl methacrylate (14 parts), and azobisisobutyronitrile (2.3 parts) was added dropwise by means of the dropping pump at 110° C. or below at a constant rate over a period of 3 hours. After the completion of the addition, the whole was kept at 110° C. for 60 minutes under continuous stirring. Thereafter, a solution of azobisisobutyronitrile (0.5 part) dissolved in butyl acetate (7 parts) was added, as an additional catalyst, dropwise at a constant rate over a period of 60 minutes. After the completion of the addition, the whole was kept at 110° C. for 60 minutes and the reaction was completed. The resulting solution of an acrylic resin having hydroxyl group is a homogeneous transparent solution containing a non-volatile matter of 55%, Gardner viscosity being X. Moreover, the acrylic resin has a weight average molecular weight of 18000, a hydroxyl value of 60, and Tg of 60° C.

### Production of Resin Fine Particles

To a 1 liter flask fitted with a stirring apparatus, a thermometer, a cooler, and a heating mantle were added deionized water (3547.5 parts) and “Latemul S-120A” (manufactured by Kao Corporation, a sulfosuccinic acid-type allyl group-containing anionic reactive emulsifier, a 50% aqueous solution) (40 parts), and the whole was warmed to 90° C. under stirring. Then, 20% of an aqueous solution of “VA-086” (manufactured by Wako Pure Chemical Industries, Ltd., a water-soluble azo-amide polymerization initiator) (12.5 parts) dissolved in deionized water (500 parts) was added thereto. After 15 minutes, 5% of a monomer mixture comprising styrene (300 parts), methyl methacarylate (400 parts), n-butyl acrylate (200 parts), and 1,6-hexanediol diacrylate (100 parts) was added thereto, followed by stirring for 30 minutes. Thereafter, the dropwise addition of the remaining monomer mixture and polymerization initiator aqueous solution was started, the monomer solution being added over a period of 3 hours and the polymerization initiator aqueous solution being added over a period of 3.5 hours with keeping the whole at 90° C. during the addition. After the completion of the addition of the polymerization initiator aqueous solution, the whole was kept at 90° C. for 30 minutes and then cooled to room temperature. Then, an aqueous gelatinized fine particle polymer water dispersion containing a solid matter of 20% was obtained by isolation using a filtering cloth. The particle size was 72 nm. The product was dried over a stainless pad to obtain resin fine particles G.

### Preparation of Coating Composition for Undercoat

### Example 1

To the acrylic resin solution containing a solid matter of 55% (25 parts) produced in the above were added the above resin fine particles G (0.3 part), xylene (22 parts), a pigment dispersant containing a tertiary amino group (2.6 parts), titanium white (10 parts), talc (15 parts), barium sulfate (10 parts), calcium carbonate (15 parts), and dibutyltin dilaurate (0.1 part), successively. The whole was mixed and stirred for 30 minutes for dispersing them to obtain a main agent. To the main agent (100 parts) was mixed “Duranate TPA90EK” (manufactured by Asahi Kasei Corporation, a polyisocyanate compound) (40 parts) immediately before use to obtain a coating composition for undercoat.

### Examples 2 to 4 and Comparative Examples 1 to 3

Each coating composition for undercoat was obtained in a similar manner to Example 1 with the exception that the formulation shown in Table 1 was used instead of that in Example 1.

The state of the main agent of each coating composition obtained in the above was evaluated after 6 months storage at 40° C. And, ⊚ shows that no problem is observed, ◯ shows that slight thickening occurs but no precipitation nor agglomeration of the pigment is observed, and × shows that the pigment is precipitated or agglomerated to form a hard cake.

TABLE 1

| | | | | Comparative | | |
|---|---|---|---|---|---|---|
| Example | | | | Example | | |
| 1 | 2 | 3 | 4 | 1 | 2 | 3 |

Main agent

| 55% Acrylic resin | | 25 | 25 | 25 | 25 | 25 | 25 | 25 |
|---|---|---|---|---|---|---|---|---|
| Resin fine particle G | | 0.3 | 0.3 | 0.5 | 0.3 | 0.3 | 0.3 | — |
| Xylene | | 22 | 22 | 22.3 | 21.1 | 22 | 22.1 | 25 |
| tert-Amine-containing | | 2.6 | 2.6 | 2.6 | 2.6 | 2.6 | 2.6 | 2.6 |
| pigment dispersant | | | | | | | | |
| Titanium white | | 10 | 10 | 10 | 10 | 10 | 10 | 10 |
| Talc | | 15 | 15 | 15 | 15 | 15 | 15 | 15 |
| Barium sulfate | | 10 | 10 | 10 | 10 | 10 | 10 | 10 |
| Calcium carbonate | | 15 | 15 | 15 | 15 | 15 | 15 | 15 |
| Dibutyltin dilaurate | | 0.1 | 0.1 | 0.1 | 1.0 | 0.1 | — | — |
| Curing | Duranate | 40 | 60 | 40 | 40 | 10 | 40 | 40 |
| agent | TPA90EK | | | | | | | |

| | | | | | | | |
|---|---|---|---|---|---|---|---|
| Base viscosity (KU | 108 | 108 | 115 | 110 | 108 | 106 | 120 |
| value) | | | | | | | |
| NCO/OH equivalent | 2.5 | 3.7 | 2.5 | 2.5 | 0.7 | 2.5 | 2.5 |
| ratio | | | | | | | |
| Storage stability | ◯ | ◯ | ⊚ | ◯ | ◯ | ◯ | X |
| (40° C. × 6 months) | | | | | | | |

### Application of Coating

### Examples 5 to 8 and Comparative Examples 4 to 6

A mild steel plate of 300×100×0.8 mm was sanded with a dry-sanding P240 paper, and each coating composition for undercoat was thickened so that the solid matter at coating becomes 70% as a putty and also primer surfacer or filler, and sprayed thereon so that the dry film thickness becomes about 200 μm. After drying at 20° C. for 60 minutes, the coated film was water-sanded with a P600 paper. Thereon was sprayed “PG2K metallic base No 123” (manufactured by Kansai Paint Co. Ltd., a urethane curable base coat coating) so that the dry film thickness becomes about 15 μm. After 10 minutes of setting, the coated plate was dried at 60° C. for 10 minutes. Then, “PG2K M clear” (manufactured by Kansai Paint Co. Ltd., a urethane curable clear coating) was sprayed so that the dry film thickness becomes 40 to 50 μm and the coated plate was artificially dried at 60° C. for 20 minutes to obtain each test coated plate.

### Examples 9 to 12 and Comparative Examples 7 to 9

To a mild steel plate of 300×100×0.8 mm was applied “LUC polyputty” (manufactured by Kansai Paint Co. Ltd., an unsaturated polyester putty) so that the thickness becomes about 2 mm by means of a knife. After drying at room temperature for 60 minutes, the coated surface was sanded with a P120 dry-sanding paper so as to smoothen the surface. Each coating composition for undercoat was thickened so that solid matter at coating becomes 50% as a primer surfacer or filler and sprayed thereon so that the dry film thickness becomes about 60 μm. After drying at 20° C. for 60 minutes, the coated plate was water-sanded with a P600 paper. The plate was further coated with “Acrylic 2101 metallic base” (a cellulose acetate butyrate-modified acrylic lacquer, aerosol-type, manufactured by Kansai Paint Co. Ltd.) so that the dry film thickness becomes about 20 μm. After 10 minutes of setting at room temperature, the coated plate was coated with “PG2K one-pack clear” (a urethane curable clear, aerosol-type, manufactured by Kansai Paint Co. Ltd.) so that the dry film thickness becomes about 40 μm and then dried to obtain each test coated plate.

### Performance Test

The resulting each test coated plate was subjected to the following performance tests. The results are shown in Tables 2 and 3.

TABLE 2

| | Example | | | | Comparative Example | | |
|---|---|---|---|---|---|---|---|
| | 5 | 6 | 7 | 8 | 4 | 5 | 6 |
| Kind of Coating | Example | Example | Example | Example | Comp. | Comp. | Comp. |
| composition for | 1 | 2 | 3 | 4 | Ex. 1 | Ex. 2 | Ex. 3 |
| undercoat | | | | | | | |
| Sanding ability | ◯ | ◯ | ◯ | ◯ | ◯ | X | X |
| Suitability for | ◯ | ◯ | ◯ | ◯ | Δ | X | X |
| topcoat | | | | | | | |

TABLE 3

| | Example | | | | Comparative Example | | |
|---|---|---|---|---|---|---|---|
| | 9 | 10 | 11 | 12 | 7 | 8 | 9 |
| Kind of Coating | Example | Example | Example | Example | Comp. | Comp. | Comp. |
| composition for | 1 | 2 | 3 | 4 | Ex. 1 | Ex. 2 | Ex. 3 |
| undercoat | | | | | | | |
| Sanding ability | ◯ | ◯ | ◯ | ◯ | ◯ | X | X |
| Substrate | ◯ | ◯ | ◯ | ◯ | Δ | X | X |
| shielding ability | | | | | | | |
| Suitability for | ◯ | ◯ | ◯ | ◯ | Δ | X | X |
| topcoat | | | | | | | |

(*1) Sanding ability: a feeling at sanding was evaluated at the time when the primer surfacer or filler surface was ground with a P600 paper at the preparation of each test coated plate (◯: good, Δ: slightly entangled, ×: considerably entangled).

(*2) Substrate shielding ability: the disappearance of the scratch caused by abrasive paper at sanding the putty on the test coated plate of Examples 9 to 12 and Comparative Examples 7 to 9 was evaluated by observing the state of the coated surface of topcoat (◯: no influence of the paper scratch is observed, Δ: slight influence of the paper scratch is observed, ×: the paper scratch does not disappear and the finish property is deteriorated).

(*3) Suitability for topcoat: the luster of the coated surface for topcoat of each test coated plate was observed (◯: good, Δ: the luster slightly is deteriorated, ×: the luster is considerably deteriorated and penetrated prints is observed).

According to the present invention, the employment of an isocyanate-rich two-pack type coating wherein a specific acrylic polyol, pigment and resin fine particles are used, effects a high content of solid matter at spray coating which allows the formation of a thick film, and enables the formation of a coated film curable within a short period of time after coating and excellent in substrate-shielding ability and solvent resistance, whereby the sanding time and the time until giving topcoat can be shortened and a puttying step can be simplified in the case of a petty scratch. Moreover, the composition of the present invention is excellent in storage stability even at a high concentration of pigment and under a high temperature environment, and does not result in problems such as the precipitation and agglomeration of the pigment. The composition of the present invention is an extremely useful coating composition particularly as a primer surfacer or filler composition in the field of the coatings for automobile-repairing, furthermore a composition for puttying capable of spraying.

The disclosure of Japanese Patent Application No. 2000-296618 filed Sep. 28, 2000, including specification, drawings and claims is incorporated herein by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. A coating composition for undercoat comprising:
(A) an acrylic resin having a hydroxyl value of 30 to 85 and a weight average molecular weight of 1000 to 30000,
(B) a pigment,
(C) resin fine particles,
(D) a polyisocyanate compound, and
(E) a curing catalyst; wherein:
a ratio of isocyanate group in the (D) component to 1 equivalent of hydroxyl group in the (A) component is 2.0 to 4.0 equivalents;
content of the (B) component is from 100 to 500 parts by weight relative to 100 parts by weight of resin solid matter; and
the (C) component is mixed so as to be from 0.1 to 5% by weight as a solid matter relative to the weight of the (B) component.

2. The coating composition for undercoat according to claim 1, wherein the acrylic resin (A) is a resin obtainable by polymerizing an acrylic monomer having hydroxyl group as an essential monomer and other acrylic monomer and/or a vinyl monomer.

3. A coating method for repair comprising steps of:
conducting surface treatment at a part to be repaired; providing undercoat; and providing topcoat; wherein a coating composition for the undercoat comprises: (A) an acrylic resin having a hydroxyl value of 30 to 85 and a weight average molecular weight of 1000 to 30000, (B) a pigment, (C) resin fine particles, (D) a polyisocyanate compound, and (E) a curing catalyst; wherein:
a ratio of isocyanate group in the (D) component to 1 equivalent of hydroxyl group in the (A) component is 2.0 to 4.0 equivalents;
content of the (B) component is from 100 to 500 parts by weight relative to 100 parts by weight of the resin solid matter; and
the (C) component is mixed so as to be from 0.1 to 5% by weight as a solid matter relative to the weight of the (B) component.
